(19) United States
(12) Patent Application Publication
(10) Pub. No.: US 2020/0265363 A1
(43) Pub. Date: Aug. 20, 2020

(54) METHOD AND SYSTEM FOR DETERMINING WORKING CONDITION OF A WORKER PERFORMING QUALITATIVE EVALUATION OF PRODUCTS

(71) Applicant: Wipro Limited, Bangalore (IN)

(72) Inventors: Ullam Subbaraya Yadhunandan, Bangalore (IN); Rahul Siripurapu, Hyderabad (IN); Ashwani Tiwari, Madhva (IN)

(21) Appl. No.: 16/370,949

(22) Filed: Mar. 30, 2019

(30) Foreign Application Priority Data
Feb. 15, 2019 (IN) 201941006140

(51) Int. Cl. G06Q 10/06; G06K 9/00; G06K 9/32; G06K 9/62

(52) U.S. Cl. CPC G06Q 10/06398; G06Q 10/06395; G06K 9/00261; G08B 21/06; G06K 9/6267; G06K 9/6256; G06K 9/3233

(57) ABSTRACT

Disclosed herein is method and worker monitoring system for determining working condition of a worker performing qualitative evaluation of products. In some embodiments, a head pose and a position of the worker are detected from plurality of image frames of a predetermined work location of the worker. Thereafter, the head pose is classified into one of a distraction pose and a non-distraction pose upon verifying that the position of worker is within a specified region of interest in the predetermined work location. Finally, working condition of the worker is determined based on classification of the head pose and predetermined operating parameters. In an embodiment, the present disclosure automatically detects when the worker is in a distracted work condition and recommends reverification of the products which were evaluated during the distracted work condition of the worker. Thus, the present disclosure enhances accuracy and reliability of qualitative evaluation of the products.

This application claims the benefit of Indian Patent Application Serial No. 201941006140 filed Feb. 15, 2019, which is hereby incorporated by reference in its entirety.

### FIELD

The present subject matter is, in general, related to production industry and more particularly, but not exclusively, to method and system for determining working condition of a worker performing qualitative evaluation of products.

### BACKGROUND

Presently, some industries in the manufacturing domain need manual inspection of supply chain for ensuring quality of products and processes involved. However, the manual inspection is inevitably plagued with procedural or skill-based errors and incurs additional losses to the industries due to loss of customer trust.

One of the ways to control these losses is by quantitatively evaluating the manual inspection. Any measure of attention or distraction of a quality inspector/worker during the manual inspection may be used to perform the quantitative evaluation of the manual inspection. Additionally, factors such as presence or absence of the worker at a designated place of manual inspection and sleeping conditions of the worker may be also used for evaluating quality of the manual inspection.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a method for determining working condition of a worker performing qualitative evaluation of products. The method includes capturing, by a worker monitoring system, video of a predetermined work location and converting the video into a plurality of image frames. Further, the method includes detecting a head pose and a position of the worker by analyzing the plurality of image frames using one or more predetermined image processing techniques. Thereafter, the method includes classifying the head pose into one of a distraction pose and a non-distraction pose using pretrained deep learning models, upon verifying the position of the worker within a specified region of interest in the predetermined work location. Finally, the method includes determining the working condition of the worker based on the classification of the head pose and one or more predetermined operating parameters.

Further, the present disclosure relates to worker monitoring system for determining working condition of a worker performing qualitative evaluation of products. The worker monitoring system includes a processor and a memory. The memory is communicatively coupled to the processor and stores processor-executable instructions, which on execution, cause the processor to capture video of a predetermined work location and convert the video into a plurality of image frames. Further, the instructions cause the processor to detect a head pose and a position of the worker by analyzing the plurality of image frames using one or more predetermined image processing techniques. Thereafter, the instructions cause the processor to classify the head pose into one of a distraction pose and a non-distraction pose using pretrained deep learning models, upon verifying the position of the worker within a specified region of interest in the predetermined work location. Finally, the instructions cause the processor to determine the working condition of the worker based on the classification of the head pose and one or more predetermined operating parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1 illustrates an exemplary environment for determining working condition of a worker performing qualitative evaluation of products in accordance with some embodiments of the present disclosure;

FIG. 2 shows a detailed block diagram illustrating a worker monitoring system in accordance with some embodiments of the present disclosure;

FIG. 3A shows a flowchart illustrating a method for classifying head poses in accordance with some embodiments of the present disclosure;

FIG. 3B shows a flowchart illustrating a method of generating alarm events in accordance with some embodiments of the present disclosure;

FIG. 4 shows a flowchart illustrating a method of determining working condition of a worker performing qualitative evaluation of products in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a worker monitoring system for determining working condition of a worker performing qualitative evaluation of products. In an embodiment, the working condition of the worker may be a distracted working condition or a non-distracted work condition. Further, the distracted working condition may be verified by detecting distraction, absence or sleeping activities of the worker. In some implementations, the worker monitoring system may use a roof mounted video camera, which is mounted at a distance away from the worker, to capture a video of a predetermined work location of the worker. Further, the captured video may be converted into image frames and analyzed for detecting a head pose and a position of the worker within the predetermined work location. Thereafter, if the worker is verified to be within a specified region of interest in the predetermined work location, the head pose may be classified into one of a distraction pose and a non-distraction pose. Finally, the working condition of the worker may be determined based on the classification of the head pose of the worker and predetermined operating parameters.

Thus, the worker monitoring system helps in automatically determining the working conditions of the worker. Also, the worker monitoring system helps in detecting the products that require reverification due to distracted work condition of the worker, thereby enhancing accuracy and reliability of the qualitative evaluation of the products.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

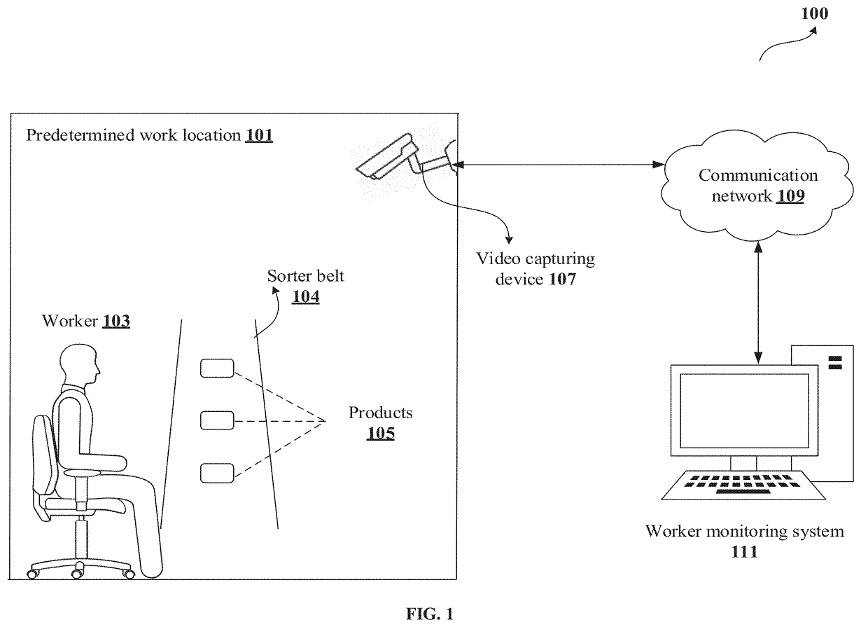

FIG. 1 illustrates an exemplary environment for determining working condition of a worker 103 performing qualitative evaluation of products 105 in accordance with some embodiments of the present disclosure.

In an embodiment, the environment 100 may include, without limiting to, a predetermined work location 101, a communication network 109 and a worker monitoring system 111. The predetermined work location 101 may be a product inspection section or a production site of an industry. In an embodiment, the predetermined work location 101 may include, without limiting to, a worker 103, a sorter belt 104, one or more products 105 on the sorter belt 104 that are being evaluated by the worker 103 and a video capturing device 107. As an example, the worker 103 may be a product quality inspector. Further, the worker 103 may perform qualitative evaluation and/or inspection of the products 105 to identify one or more defective products and to separate them from the batches of non-defective products. In an embodiment, the products 105 may be rolled-over on the moving sorter belt 104 and the worker 103 may identify the one or more defective products 105 by manually evaluating/inspecting the products 105 being rolled-over on the sorter belt 104.

In an embodiment, the video capturing device 107 may be installed within the predetermined work location 101 of the worker 103. In some implementations, the video capturing device 107 may be mounted on roof or walls of the predetermined work location 101, such that the video capturing device 107 may capture an entire region of interest around the worker 103. As an example, the video capturing device 107 may be a Close Circuit Television (CCTV) camera, an analogue camera or an Internet Protocol (IP) camera. In some implementations, the video capturing device 107 may capture live feed of the predetermined work location 101 and stream it to a Network Video Recorder (NVR) or a Digital Video Recorder (DVR) associated with the communication network 109. In some embodiments, without limitations, the predetermined work location 101 may be installed with more than one video capturing devices based on number of workers in the predetermined work location 101 and/or region of interests to be captured in the predetermined work location 101.

In an embodiment, the video capturing device 107 may transmit a video of the predetermined work location 101 to the worker monitoring system 111 via the communication network 109. In another embodiment, for optimal utilization of network resources associated with the communication network 109, the video capturing device 107 may be configured to convert the video into a plurality of image frames and transmit the plurality of image frames to the worker monitoring system 111 via the communication network 109. In an embodiment, the communication network 109 may be a wired communication network 109 or a wireless communication network 109.

In an embodiment, the worker monitoring system 111 may be any computing device including, without limitation, a desktop computer, a laptop, a server and the like. Further, the worker monitoring system 111 may be configured at a remote location and the video and/or one or more images of the predetermined work location 101 may be transmitted to the worker monitoring system 111 through the communication network 109.

In an embodiment, upon receiving the video of the predetermined work location 101, the worker monitoring system 111 may convert the video into a plurality of images frames. Further, the worker monitoring system 111 may detect a head pose and a position of the worker 103 by analysing the plurality of image frames using one or more predetermined image processing techniques. Additionally, the worker monitoring system 111 may also detect a plurality of key points, corresponding to the worker 103, from the plurality of image frames. As an example, the plurality of key points may include, without limiting to, head of the worker, chest of the worker, shoulder of the worker and other parts of the worker such as arms, arm joints, elbow, palm, neck and the like.

In an embodiment, upon detecting the position of the worker 103 within the predetermined work location 101 and detecting the head pose, the worker monitoring system 111 may classify the head pose into one of a distraction pose and a non-distraction pose using pretrained deep learning models configured in the worker monitoring system 111. Thereafter, the worker monitoring system 111 may determine the working condition of the worker 103 based on the classification of the head pose and one or more predetermined operating parameters. As an example, the one or more predetermined operating parameters considered for determining the working condition of the worker 103 may include, without limiting to, a threshold time of distraction, a threshold time of absence of the worker 103 from the predetermined work location 101, a threshold time period for detecting sleep condition of the worker 103 and the like.

In an embodiment, the working condition of the worker 103 may be at least one of a non-distracted work condition and a distracted work condition. The non-distracted work condition may refer to the working condition in which the worker 103 is active and evaluating the products 105 without any distractions. Similarly, the distracted work condition may refer to the working condition in which the worker 103 is in a distraction condition, a sleep condition or an absence condition. In an embodiment, the distraction condition may be detected when the worker 103 is not actively involved in evaluating the products 105, for example, when the worker 103 is engaged in a conversation with co-workers. Further, the sleep condition may be detected when the worker 103 is sleeping or drooping for a threshold time period. Similarly, the worker 103 absence condition may be detected when the position of the worker 103 is not detected within the specified region of interest in the plurality of image frames.

In an embodiment, upon determining the working condition of the worker 103 to be one of the distracted work conditions, the worker monitoring system 111 may generate an alarm event corresponding to the distracted work condition of the worker 103. Further, the worker monitoring system 111 may combine a plurality of image frames corresponding to the distracted work condition of the worker 103 into a video. Thereafter, the worker monitoring system 111 may transmit the alarm event and the video to predetermined worker 103 management personnel for notifying the distracted work condition of the worker 103. In an embodiment, the worker 103 management personnel, upon receiving the alarm event and the video, may review the video to identify one or more products 105 requiring re-verification. That is, the worker monitoring system 111 helps in automatically detecting the working conditions of the worker 103 and thereby helps in identifying the one or more products 105 that need to be cross-verified. Thus, the worker monitoring system 111 enhances correctness and reliability of the product evaluation process.

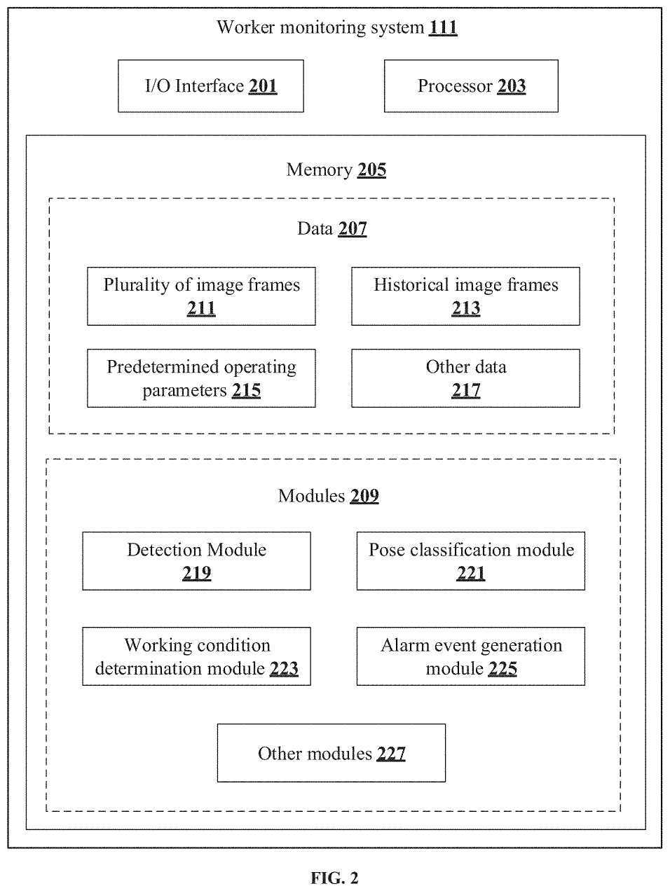

FIG. 2 shows a detailed block diagram illustrating a worker monitoring system 111 in accordance with some embodiments of the present disclosure.

In some implementations, the worker monitoring system 111 may include an I/O interface 201, a processor 203, and a memory 205. The I/O interface 201 may be configured to receive a video and/or one or more image frames of a predetermined work location 101 of the worker 103 from a video capturing device 107 associated with the worker monitoring system 111. The memory 205 may be communicatively coupled to the processor 203 and may store data 207 and one or more modules 209. The processor 203 may be configured to perform one or more functions of the worker monitoring system 111 for determining working condition of the worker 103, using the data 207 and the one or more modules 209.

In an embodiment, the data 207 may include, without limitation, plurality of image frames 211, historical image frames 213, predetermined operating parameters 215 and other data 217. In some implementations, the data 207 may be stored within the memory 205 in the form of various data structures. Additionally, the data 207 may be organized using data models, such as relational or hierarchical data models. The other data 217 may store various temporary data and files generated by one or more modules 209 while performing various functions of the worker monitoring system 111. As an example, the other data 217 may also include, without limiting to, plurality of training images, distinct head poses extracted from the historical image frames 213, a histogram of the distinct head poses and details of the alarm event.

In an embodiment, the plurality of image frames 211 may be obtained from the video of the predetermined work location 101, captured by the video capturing device 107. The plurality of image frames 211 may be analyzed using one or more predetermined image processing techniques for detecting a head pose and a position of the worker 103. In an embodiment, the head pose may indicate pose of the head of the worker 103. The position of the worker 103 may indicate actual location of the person within the predetermined work location 101. As an example, the one or more predetermined image processing techniques may include, without limiting to, Region-based Convolutional Neural Networks (R-CNN), Opensource Computer Vision library (OpenCV) and the like.

In an embodiment, the historical image frames 213 are plurality of image frames 211 of the predetermined work location 101, which are captured for training the one or more predetermined image processing techniques.

In an embodiment, the predetermined operating parameters 215 are the parameters, based on which, the worker monitoring system 111 determines the working condition of the worker 103. As an example, the one or more predetermined operating parameters 215 may include, without limiting to, a threshold time of distraction, a threshold time of absence of the worker 103 from the predetermined work location 101 and a threshold time period for detecting sleep condition of the worker 103. The threshold time of distraction may indicate analysis of frames within the time period for which the worker 103 may be allowed to relax and/or deviate from evaluating the products 105. As an example, the threshold time of distraction may be three seconds. That is, if the worker 103 is detected to be distracted for more than three seconds, then the worker monitoring system 111 may determine that the worker 103 is in a distracted work condition. Similarly, the threshold time of absence of the worker 103 indicates the time period for which the worker 103 may be allowed to leave the predetermined work location 101. As an example, the threshold time of absence may be 1 minute. Further, the threshold time period for detecting the sleep condition may indicate a time period, upon completion of which, the worker monitoring system 111 initiates detection of sleeping condition of the worker 103. As an example, suppose the threshold time period is 40 seconds. Here, the sleep condition of the worker 103 may be determined after detecting that the worker 103 is inactive and/or drooping for more than 40 seconds.

In an embodiment, the data 207 may be processed by the one or more modules 209. In some implementations, the one or more modules 209 may be communicatively coupled to the processor 203 for performing one or more functions of the worker monitoring system 111. In an implementation, the one or more modules 209 may include, without limiting to, a detection module 219, a pose classification module 221, a working condition determination module 223, an alarm event generation module 225 and other modules 227.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. In an embodiment, the other modules 227 may be used to perform various miscellaneous functionalities of the worker monitoring system 111. It will be appreciated that such one or more modules 209 may be represented as a single module or a combination of different modules.

In an embodiment, the detection module 219 may be configured to detect a head pose and a position of the worker 103 by analysing the plurality of image frames 211. In some implementations, the detection module 219 may be trained with the one or more predetermined image processing techniques for detecting the head pose and the position of the worker 103 from the plurality of image frames 211. As an example, training of the detection module 219 may include receiving a plurality of training images, having one or more distinct head poses of the worker 103, from a training database associated with the worker monitoring system 111. The plurality of training images may include the historical and/or pre-captured reference images of the worker 103, which are annotated and stored in the training database.

In an embodiment, training the detection module 219 further includes segregating the one or more distinct head poses into one or more classes of head poses based on an angle of the one or more distinct head poses. As an example, the angle of the head pose may indicate an angle between the head and shoulder region of the worker 103. Thus, each class of the head poses may include one or more poses having similar/same angle of the head poses. Further, upon segregating the one or more distinct head poses, the plurality of training images, corresponding to the one or more distinct head poses, may be annotated to the one or more classes of head poses based on similarity between the angle of the head poses. Upon completion of the training process, the detection module 219 may detect the head pose of the worker 103 from the plurality of image frames 211 that are extracted from a live stream or video of the predetermined work location 101.

In an embodiment, the pose classification module 221 may be used for classifying the head pose into one of a distraction pose and a non-distraction pose using pre-trained deep learning models. As an example, the pre-trained deep learning models may be, without limiting to, Convolutional Neural Network (CNN) models. In an embodiment, the classification of the head pose may be performed upon verifying that the position of the worker 103 is within a specified region of interest in the predetermined work location 101. As an example, the specified region of interest may be a region within two meters from the products 105 and/or the sorter belt 104. That is, the classification of the head poses may be performed only upon determining that the worker 103 is within the region of two meters from the products 105. In an embodiment, the pose classification module 221 may classify the head pose by comparing the head pose with one or more classes of head poses, which are stored in the training database. As an example, the one or more classes of head poses may include one or more distraction poses and one or more non-distraction poses. Thus, the pose classification module 221 may classify the pose as the distraction pose when the pose matches with the one or more distraction poses included in the one or more classes of head poses. Similarly, the pose classification module 221 may classify the pose as the non-distraction pose when the pose does not match with any of the distraction poses included in the one or more classes of head poses.

In an embodiment, the deep learning models may be trained for detecting the distraction poses using plurality of historical image frames 213, which are stored in the training database. In some implementations, training the deep learning models includes extracting one or more distinct head poses of the worker 103 from the plurality of historical image frames 213. Thereafter, a histogram of the one or more distinct head poses extracted from the plurality of image frames 211 may be generated. Subsequently, the histogram of the distinct head poses may be analysed to identify a mean frequency value of the one or more distinct head poses. As an example, the mean frequency value of the one or more distinct head poses may indicate the most frequently occurring head poses and least frequently occurring head poses of the worker 103. In an embodiment, upon identifying the mean frequency of the one or more distinct poses, the one or more distinct head poses may be annotated as the one or more distraction poses based on the mean frequency value. As an example, the one or more head poses whose peak value is less than the mean frequency value may be considered as least frequently occurring head poses and thus, may be classified as the one or more distraction poses. In an embodiment, the head poses that are not annotated as a distracted pose may be annotated and classified as the non-distracted head poses.

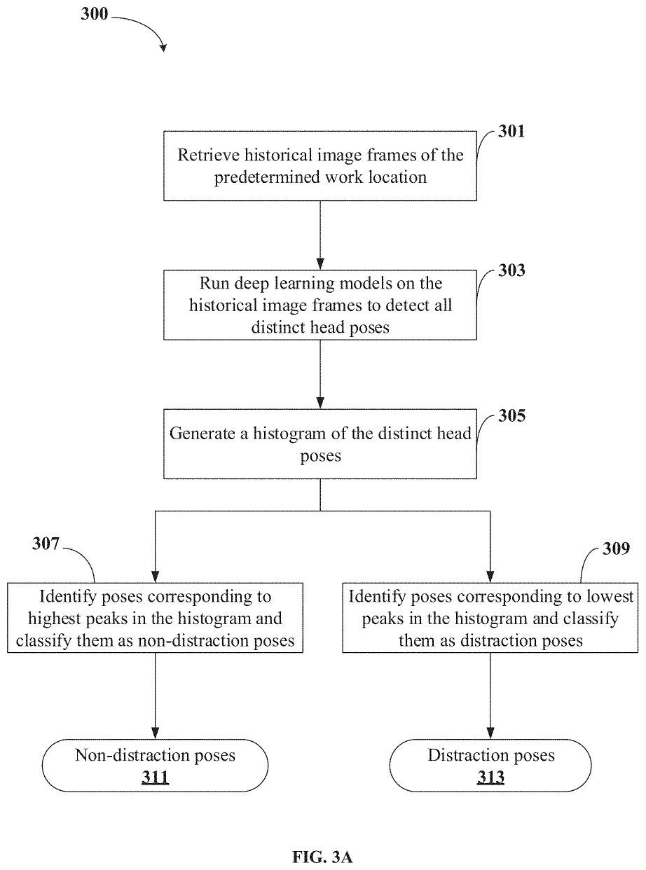

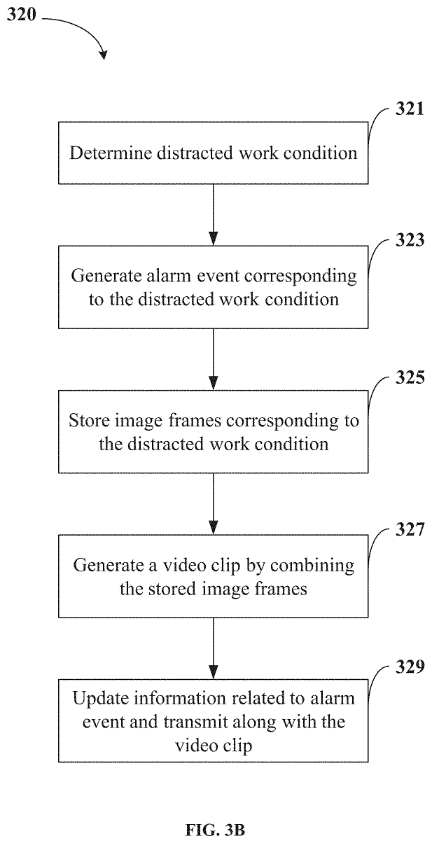

Various steps involved in classifying the head pose into one of a distraction pose and a non-distraction pose using the pre-trained deep learning models are represented in flowchart of FIG. 3A. At step 301, a plurality of historical image frames 213 of the predetermined work location 101 may be retrieved from a training database associated with the worker monitoring system 111. At step 303, the pre-trained deep learning models may be run on the plurality of historical image frames 213 for detecting all the distinct head poses from the plurality of historical image frames 213. Thereafter, at step 305, a histogram of all the distinct head poses may be generated, and a mean frequency value of the histogram may be determined. Further, at step 307, one or more distinct poses whose peak values are more than the mean frequency value may be identified and classified as the one or more non-distraction poses, as indicated at block 311. Similarly, at step 309, the one or more distinct poses whose peak values are less than the mean frequency value may be identified and classified as the one or more distraction poses, as indicated at block 313.

In an embodiment, the working condition determination module 223 may be configured for determining the working condition of the worker 103 based on the classification of the head pose and one or more predetermined operating parameters 215. The working condition of the worker 103 may be one of a non-distracted work condition and a distracted work condition. Further, the distracted work condition may be classified as a distraction condition, a sleep condition and a worker absence condition.

In an embodiment, when the head pose is classified as the distracted pose, the working condition determination module 223 may determine the working condition as the distracted working condition, upon verifying that the one or more predetermined operating parameters 215 relating to the distracted working condition are satisfied. As an example, the predetermined operating parameters 215 comprise at least one of a threshold time of distraction, a threshold time of absence of the worker 103 from the predetermined work location 101 and a threshold time period for detecting sleep condition of the worker 103.

In an embodiment, the working condition of the worker 103 may be determined as the distraction condition when the head pose is classified as the distraction pose and the head pose remains to be in the distracted pose for more than the threshold time of distraction. As an example, the distraction condition may be determined when the worker 103 carries the distraction pose for more than 3 seconds, that is, more than the threshold time of distraction. In other words, suppose if the head pose is identified as distraction in a first image frame of the predetermined work location, the distraction condition may be confirmed only when the subsequent image frames received over next 3 seconds are also identified as distraction. Alternatively, the distraction may be confirmed when a predefined number of all the image frames processed during the threshold time of 3 seconds are identified as distraction. As an example, the predefined number may be 85% of the image frames. In such scenarios, the distraction condition may be confirmed when more than 85% of all the image frames represent distraction of the worker 103. The above analysis may be used for confirming the sleeping condition of the worker 103.

In an embodiment, the working condition of the worker 103 may be determined as the sleeping condition based on the threshold time period for detecting the sleep condition of the worker 103.

In an embodiment, the working condition of the worker 103 may be determined as the worker absence condition when the position of the worker 103 is not detected within the specified region of interest in the plurality of image frames 211 for more than a threshold time of absence. As an example, the threshold time of absence may be 1 minute. Accordingly, the worker 103 may be detected to be absent from the predetermined work location 101 when the worker 103 is not detected in the plurality of image frames 211 extracted from the video over 1 minute.

In an embodiment, the alarm event generation module 225 may be configured for generating an alarm event when the working condition of the worker 103 is determined as the distracted work condition. In an embodiment, the alarm event generation module 225 may also be configured for combining a plurality of image frames 211 corresponding to the distracted work condition of the worker 103 into a video. The video may be used as an evidence that the worker 103 was in a distracted working condition during evaluation of the products 105. Additionally, the video may be used to determine batches of products 105 that need to be re-evaluated and/or re-verified since the worker 103 was in a distracted working condition. In an embodiment, upon forming the video, the alarm event generation module 225 may transmit the alarm event and the video to predetermined worker 103 management personnel for notifying the distracted work condition of the worker 103. Thereafter, the worker 103 management personnel may perform re-verification of the products 105 that were identified from the video. In an embodiment, the products 105 to be re-verified may be identified based on a timestamp corresponding to the video. As an example, all the products 105 that were passed through the sorter belt 104 between a start time and an end time of the video may be selected for re-verification.

FIG. 3B illustrates various steps involved in generating an alarm event corresponding to the distracted working condition of the worker 103. At step 321, a distracted work condition of the worker 103 may be determined based on classification of the head pose and the one or more predetermined operating parameters 215. In an embodiment, step 321 may also include classifying the distracted work condition into one of a distraction condition, a sleeping condition and a worker absence condition for determining type of the alarm element to be generated. Further, at step 323, the alarm event corresponding to the determined distracted work condition may be generated. Subsequently, at step 325, the plurality of image frames 211 that correspond to the determined distracted work condition may be retrieved and stored for generating a video clip. Further, at step 327, the plurality of image frames 211 may be combined to form a video clip of the distracted work condition of the worker 103. Thereafter, at step 329, information related to the alarm event may be updated and transmitted to predetermined worker management personnel, along with the video clip corresponding to the distracted work condition of the worker 103.

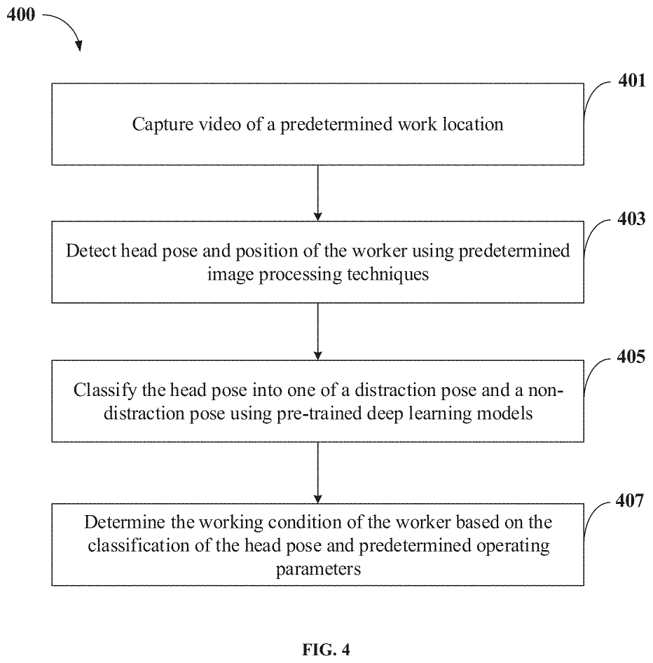

FIG. 4 shows a flowchart illustrating a method of determining working condition of a worker 103 performing qualitative evaluation of the products 105 in an enterprise in accordance with some embodiments of the present disclosure.

As illustrated in FIG. 4, the method 400 may include one or more blocks illustrating a method for determining working condition of a worker 103 performing qualitative evaluation of products 105 using the worker monitoring system 111 illustrated in FIG. 1. The method 400 may be described in the general context of computer executable instructions. Generally, computer executable instructions can include routines, programs, objects, components, data structures, procedures, modules, and functions, which perform specific functions or implement specific abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 401, the method 400 includes capturing, by the worker monitoring system 111, a video of a predetermined work location 101 of the worker 103. In an embodiment, the video of the predetermined work location 101 may be captured by a video capturing device 107 configured at the predetermined work location 101. Further, the captured video may be converted into a plurality of image frames 211.

At block 403, the method 400 includes detecting, by the worker monitoring system 111, a head pose and a position of the worker 103 by analysing the plurality of image frames 211 using one or more predetermined image processing techniques. In an embodiment, the worker monitoring system 111 may be trained with the one or more predetermined image processing techniques for detecting the head pose. In an embodiment, the training process may include receiving a plurality of training images with one or more distinct head poses of the worker 103. Further, the one or more distinct head poses may be segregated into one or more classes of head poses based on an angle of the one or more distinct head poses. Thereafter, the plurality of training images, corresponding to the one or more distinct head poses, may be annotated to the one or more classes of head poses.

At block 405, the method 400 includes classifying, by the worker monitoring system 111, the head pose into one of a distraction pose and a non-distraction pose using pre-trained deep learning models, upon verifying the position of the worker 103 within a specified region of interest in the predetermined work location 101. In an embodiment, classifying the head pose comprises comparing the head pose with one or more classes of head poses. As an example, the one or more classes of head poses may include one of one or more distraction poses and one or more non-distraction poses.

In an embodiment, training the deep learning models for detecting the one or more distraction poses may include extracting one or more distinct head poses of the worker 103 from a plurality of historical image frames 213 of the predetermined work location 101. Further, the training process may include generating a histogram of each of the one or more distinct head poses and identifying a mean frequency value of the one or more distinct head poses from the histogram. Finally, the one or more distinct head poses may be annotated as the one or more distraction poses based on the mean frequency value.

At block 407, the method 400 includes determining, by the worker monitoring system 111, the working condition of the worker 103 based on the classification of the head pose and one or more predetermined operating parameters 215. As an example, the one or more predetermined operating parameters 215 may include, without limiting to, at least one of a threshold time of distraction, a threshold time of absence of the worker 103 from the predetermined work location 101 and a threshold time period for detecting sleep condition of the worker 103. In an embodiment, the working condition of the worker 103 may be at least one of a non-distracted work condition and a distracted work condition. Further, the distracted work condition may include a distraction condition, a sleep condition and a worker 103 absence condition.

In an embodiment, the sleep condition of the worker 103 may be determined by identifying a plurality of key points, corresponding to the worker 103, on each of the plurality of image frames 211. As an example, the plurality of key points may represent at least one of head of the worker 103, chest of the worker 103, shoulder of the worker 103 and arms of the worker 103. In an embodiment, upon identifying the plurality of key points, angles between the plurality of key points may be compared with corresponding predetermined reference angles for a predetermined time period for determining deviation in the angles. Finally, the sleep condition of the worker 103 may be determined based on the deviation in the angles. In an embodiment, the worker 103 absence condition may be determined when the position of the worker 103 is not detected within the region of interest in the plurality of image frames 211.

In an embodiment, subsequent to determining the working condition of the worker 103, the worker monitoring system 111 may generate an alarm event corresponding to the distracted work condition of the worker 103. Further, the worker monitoring system 111 may combine a plurality of image frames 211 corresponding to the distracted work condition of the worker 103 into a video and transmit the alarm event and the video to predetermined worker 103 management personnel for notifying the distracted work condition of the worker 103. In an embodiment, the alarm event may include information related to at least one of time of occurrence of the distracted work condition, duration of the distracted work condition, predetermined work location 101 of the worker 103 and product identifiers corresponding to one or more products 105 that were passed on the sorter belt 104 during the distracted work condition of the worker 103.

### Computer System

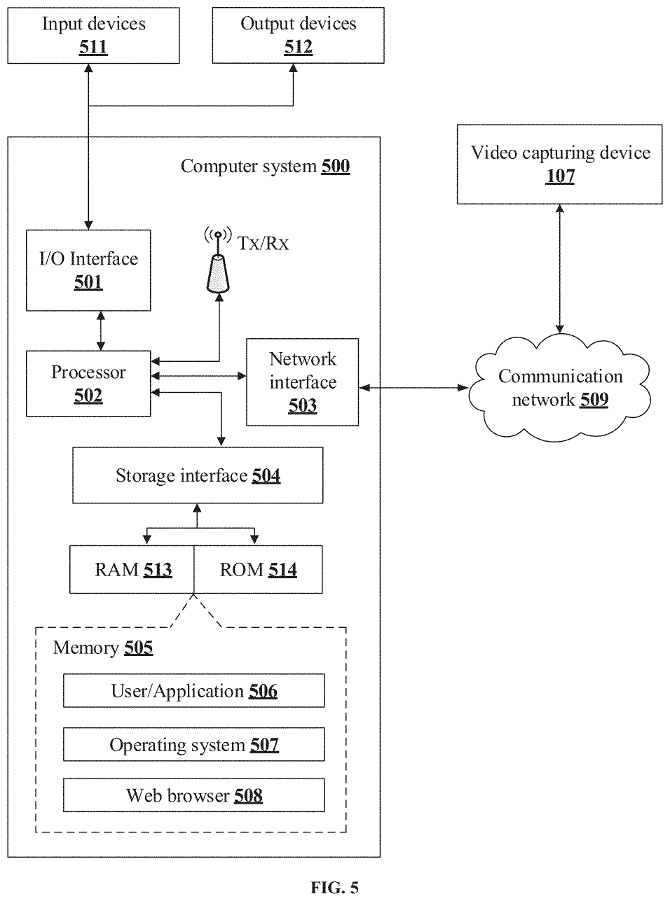

FIG. 5 illustrates a block diagram of an exemplary computer system 500 for implementing embodiments consistent with the present disclosure. In an embodiment, the computer system 500 may be the worker monitoring system 111 illustrated in FIG. 1, which may be used for determining working condition of a worker 103 performing qualitative analysis of products 105. The computer system 500 may include a central processing unit (“CPU” or “processor”) 502. The processor 502 may comprise at least one data processor for executing program components for executing user- or system-generated business processes. A worker may include a person, a product quality inspector, or any system/sub-system being operated parallelly to the computer system 500. The processor 502 may include specialized processing units such as integrated system (bus) controllers, memory management control units, floating point units, graphics processing units, digital signal processing units, etc.

The processor 502 may be disposed in communication with one or more input/output (I/O) devices (511 and 512) via I/O interface 501. The I/O interface 501 may employ communication protocols/methods such as, without limitation, audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 501, the computer system 500 may communicate with one or more I/O devices 511 and 512.

In some embodiments, the processor 502 may be disposed in communication with a communication network 509 via a network interface 503. The network interface 503 may communicate with the communication network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc. Using the network interface 503 and the communication network 509, the computer system 500 may communicate with a video capturing device 107 configured at a predetermined work location 101 of the worker 103 for receiving a video and/or one or more images of the predetermined work location 101.

In an implementation, the communication network 509 may be implemented as one of the several types of networks, such as intranet or Local Area Network (LAN) and such within the organization. The communication network 509 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 509 may include a variety of network devices, including routers, bridges, servers, computing devices, storage devices, etc.

In some embodiments, the processor 502 may be disposed in communication with a memory 505 (e.g., RAM 513, ROM 514, etc. as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application interface 506, an operating system 507, a web browser 508, and the like. In some embodiments, computer system 500 may store user/application data 506, such as the data, variables, records, etc. as described in this invention. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE® MACINTOSH® OS X°, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like.

The user interface 506 may facilitate display, execution, interaction, manipulation, or operation of program components through textual or graphical facilities. For example, the user interface 506 may provide computer interaction interface elements on a display system operatively connected to the computer system 500, such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (e.g., Aero, Metro, etc.), web interface libraries (e.g., ActiveX®, JAVA®, JAVASCRIPT®, AJAX, HTML, ADOBE® FLASH®, etc.), or the like.

The web browser 508 may be a hypertext viewing application. Secure web browsing may be provided using Secure Hypertext Transport Protocol (HTTPS), Secure Sockets Layer (SSL), Transport Layer Security (TLS), and the like. The web browsers 508 may utilize facilities such as AJAX, DHTML, ADOBE® FLASH®, JAVASCRIPT®, JAVA®, Application Programming Interfaces (APIs), and the like. Further, the computer system 500 may implement a mail server stored program component. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 500 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Advantages of the Embodiments of the Present Disclosure are Illustrated Herein

In an embodiment, the method of present disclosure helps in determining work condition of a worker while the worker is performing qualitative analysis of products.

In an embodiment, the worker monitoring system of present disclosure automatically detects when the worker is distracted, sleeping or absent from the work location and generates dynamic alarm events to notify concerned worker management personnel about the working condition of the worker.

In an embodiment, the method of present disclosure marks all the unevaluated products as unverified or requiring reverification and notifies the worker management personnel, thereby ensuring that all the unevaluated products are duly verified.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for determining working condition of a worker performing qualitative evaluation of products, the method comprising:
capturing, by a worker monitoring device, video of a predetermined work location, wherein the video is converted into a plurality of image frames;
detecting, by the worker monitoring device, a head pose and a position of the worker by analysing the plurality of image frames using one or more predetermined image processing techniques;
classifying, by the worker monitoring device, the head pose into one of a distraction pose and a non-distraction pose using pretrained deep learning models, upon verifying the position of the worker within a specified region of interest in the predetermined work location; and
determining, by the worker monitoring device, the working condition of the worker based on the classification of the head pose and one or more predetermined operating parameters.

2. The method as claimed in claim 1 comprises training the worker monitoring device with the one or more predetermined image processing techniques for detecting the head pose, wherein the training comprises:
receiving a plurality of training images with one or more distinct head poses of the worker;
segregating the one or more distinct head poses into one or more classes of head poses based on an angle of the one or more distinct head poses; and
annotating the plurality of training images, corresponding to the one or more distinct head poses, to the one or more classes of head poses.

3. The method as claimed in claim 1, wherein classifying the head pose comprises comparing the head pose with one or more classes of head poses and wherein the one or more classes of head poses comprises one of one or more distraction poses and one or more non-distraction poses.

4. The method as claimed in claim 3, wherein the one or more distraction poses are obtained by:
extracting one or more distinct head poses of the worker from a plurality of historical image frames of the predetermined work location, using the one or more predetermined image processing techniques;
generating a histogram of each of the one or more distinct head poses;
identifying a mean frequency value of the one or more distinct head poses from the histogram; and
classifying the one or more distinct head poses as the one or more distraction poses based on the mean frequency value.

5. The method as claimed in claim 1, wherein the one or more predetermined operating parameters comprise at least one of a threshold time of distraction, a threshold time of absence of the worker from the predetermined work location and a threshold time period for detecting sleep condition of the worker.

6. The method as claimed in claim 1, wherein the working condition of the worker is at least one of a non-distracted work condition and a distracted work condition, wherein the distracted work condition includes a distraction condition, a sleep condition and a worker absence condition.

7. The method as claimed in claim 6, wherein the sleep condition of the worker is determined by:
identifying a plurality of key points, corresponding to the worker, on each of the plurality of image frames, wherein the plurality of key points represent at least one of head of the worker, chest of the worker, shoulder of the worker and arms of the worker;
comparing angles between the plurality of key points with corresponding predetermined reference angles for a predetermined time period for determining deviation in the angles; and
determining the sleep condition of the worker based on the deviation in the angles.

8. The method as claimed in claim 6, wherein the worker absence condition is determined when position of the worker is not detected within specified region of interest in the plurality of image frames.

9. The method as claimed in claim 6 comprises:
generating an alarm event corresponding to the distracted work condition of the worker;
combining a plurality of image frames corresponding to the distracted work condition of the worker into a video; and
transmitting the alarm event and the video to predetermined worker management personnel for notifying the distracted work condition of the worker.

10. The method as claimed in claim 9, wherein the alarm event comprises information related to at least one of time of occurrence of the distracted work condition, duration of the distracted work condition, predetermined work location of the worker and product identifiers corresponding to one or more products evaluated by the worker during the distracted work condition.

11. A worker monitoring device comprising:
a processor; and
a memory, communicatively coupled to the processor, wherein
the memory stores processor-executable instructions, which on execution, cause the processor to:
capture video of a predetermined work location, wherein the video is converted into a plurality of image frames;
detect a head pose and a position of the worker by analysing the plurality of image frames using one or more predetermined image processing techniques;
classify the head pose into one of a distraction pose and a non-distraction pose using pretrained deep learning models, upon verifying the position of the worker within a specified region of interest in the predetermined work location; and
determine the working condition of the worker based on the classification of the head pose and one or more predetermined operating parameters.

12. The worker monitoring device as claimed in claim 11, wherein to train the worker monitoring system with the one or more predetermined image processing techniques for detecting the head pose, the processor is configured to:
receive a plurality of training images with one or more distinct head poses of the worker;
segregate the one or more distinct head poses into one or more classes of head poses based on an angle of the one or more distinct head poses; and
annotate the plurality of training images, corresponding to the one or more distinct head poses, to the one or more classes of head poses.

13. The worker monitoring device as claimed in claim 11, wherein the processor classifies the head pose comprises by comparing the head pose with one or more classes of head poses and wherein the one or more classes of head poses comprises one of one or more distraction poses and one or more non-distraction poses.

14. The worker monitoring device as claimed in claim 13, wherein to obtain the one or more distraction poses, the processor is configured to:
extract one or more distinct head poses of the worker from a plurality of historical image frames of the predetermined work location, using the one or more predetermined image processing techniques;
generate a histogram of each of the one or more distinct head poses;
identify a mean frequency value of the one or more distinct head poses from the histogram; and
classify the one or more distinct head poses as the one or more distraction poses based on the mean frequency value.

15. The worker monitoring device as claimed in claim 11, wherein the one or more predetermined operating parameters comprise at least one of a threshold time of distraction, a threshold time of absence of the worker from the predetermined work location and a threshold time period to detect sleep condition of the worker.

16. The worker monitoring device as claimed in claim 11, wherein the working condition of the worker is at least one of a non-distracted work condition and a distracted work condition, wherein the distracted work condition includes a distraction condition, a sleep condition and a worker absence condition.

17. The worker monitoring device as claimed in claim 16, wherein to determine the sleep condition of the worker, the processor is configured to:
identify a plurality of key points, corresponding to the worker, on each of the plurality of image frames, wherein the plurality of key points represent at least one of head of the worker, chest of the worker, shoulder of the worker and arms of the worker;
compare angles between the plurality of key points with corresponding predetermined reference angles for a predetermined time period to determine deviation in the angles; and
determine the sleep condition of the worker based on the deviation in the angles.

18. The worker monitoring device as claimed in claim 16, wherein the processor determines the worker absence condition when position of the worker is not detected within specified region of interest in the plurality of image frames.

19. The worker monitoring device as claimed in claim 16, wherein the processor is further configured to:
generate an alarm event corresponding to the distracted work condition of the worker;
combine a plurality of image frames corresponding to the distracted work condition of the worker into a video; and
transmit the alarm event and the video to predetermined worker management personnel to notify the distracted work condition of the worker.

20. The worker monitoring device as claimed in claim 19, wherein the alarm event comprises information related to at least one of time of occurrence of the distracted work condition, duration of the distracted work condition, predetermined work location of the worker and product identifiers corresponding to one or more products evaluated by the worker during the distracted work condition.

21. A non-transitory computer readable medium including instructions stored thereon that when processed by at least one processor cause a worker monitoring device to perform operations comprising:
capturing video of a predetermined work location, wherein the video is converted into a plurality of image frames;
detecting a head pose and a position of the worker by analysing the plurality of image frames using one or more predetermined image processing techniques;
classifying the head pose into one of a distraction pose and a non-distraction pose using pretrained deep learning models, upon verifying the position of the worker within a specified region of interest in the predetermined work location; and
determining the working condition of the worker based on the classification of the head pose and one or more predetermined operating parameters.
